(19) United States
(12) Patent Application Publication
(10) Pub. No.: US 2023/0019935 A1
(43) Pub. Date: Jan. 19, 2023

(54) Fluid Connector With Expansion Ring

(71) Applicant: Oetiker NY, Inc., Lancaster, NY (US)

(72) Inventors: Kari Ann Sausen, Clarence, NY (US); Kristian James Hagen, Gasport, NY (US); Bradley C. Fremont, Tonawanda, NY (US)

(21) Appl. No.: 17/757,508

(22) PCT Filed: Dec. 19, 2019
(86) PCT No.: PCT/US2019/067538

§ 371 Date: Jun. 16, 2022

(51) Int. Cl. F16L 37/084

(52) U.S. Cl. CPC F16L 37/0841

(57) ABSTRACT

An expansion ring for a fluid connector including a including a first end, a second end, a radially outward facing surface, and a through-bore, wherein the expansion ring is slidably engaged with the connector body.

### FIELD

The present disclosure relates to fluid connectors, and, more particularly, to a fluid connector including an expansion ring that reduces the force required to assemble.

### BACKGROUND

Fluid connectors are integral components for many applications, and especially for automotive applications. Since an automotive system is made up of various components such as a radiator, transmission, and engine, fluid must be able to travel not only within each component but also between components. An example of fluid traveling between components is the transmission fluid traveling from the transmission to the transmission oil cooler in order to lower the temperature of the transmission fluid. Fluid predominantly moves between components via flexible or rigid hoses which connect to each component by fluid connectors. Such fluid connectors typically include a retaining clip, retaining ring clip, or snap ring carried on the connector body which is adapted to snap behind a raised shoulder of a tube end form when the tube end form is fully inserted into the connector body. However, the force required to assembly fluid connectors, specifically, to insert the tube end form into the connector body is rather large. This is because the tube end form must force the retaining clip radially outward until the shoulder of the tube end form passes the retaining clip, at which point the retaining clip snaps radially inward back to its original shape.

Thus, there has been a long-felt need for a fluid connector including an expansion ring that maintains the retaining clip in a radially expanded position until the tube end form is fully inserted into the connector body, thereby reducing the insertion force required to assemble the fluid connector.

### SUMMARY

According to aspects illustrated herein, there is provided an expansion ring for a fluid connector including a connector body having a bore, a retaining clip, and a tube end form, the expansion ring comprising a first end, a second end, a radially outward facing surface, and a through-bore, wherein the expansion ring is slidably engaged with the connector body.

According to aspects illustrated herein, there is provided a fluid connector, comprising a connector body, including a first through-bore, a first groove arranged circumferentially within the first through-bore, a seal arranged within the first groove, and a retaining clip operatively arranged on the connector body to extend into the first through-bore, and an expansion ring, including a first end, a second end, a radially outward facing surface, and a second through-bore, wherein the expansion ring is slidably engaged in the first through-bore.

According to aspects illustrated herein, there is provided a fluid connector, comprising a connector body, including a first through-bore, a first groove arranged circumferentially within the first through-bore, a seal arranged within the first groove, and a retaining clip operatively arranged on the connector body to extend into the first through-bore, an expansion ring slidably engaged in the first through-bore, the expansion ring including a first end, a second end, a radially outward facing surface including a second groove, and a second through-bore, and a tube end form operatively arranged to be connected to the connector body.

According to aspects illustrated herein, there is provided a fluid connector that reduces the amount of insertion force (effort) required to assemble a tube end form into a quick connector application during the production assembly process. The fluid connector disclosed in the present disclosure decreases the insertion force requirements for tube to quick connect fluid connections to allow for ease of assembly from all assembly positions. The fluid connector comprises an integrated self-contained carrier (bezel, expansion ring, etc.) that allows the tube end form to be connected to the connector body with very low insertion force. The carrier may comprise any suitable material (e.g., metallic, polymer, ceramic, etc.). The quick connect connector body may comprise any suitable material (e.g., metallic, polymer, ceramic, etc.). The tube end form may comprise any suitable material (e.g., metallic, polymer, ceramic, etc.).

According to aspects illustrated herein, there is provided a fluid connector that comprises a self-contained assembly solution that reduces insertion forces. The carrier is arranged inside the quick connect connector body at the retaining clip slot location. The retaining clip is then arranged/installed on the connector body and engages the carrier interface. The retaining ring is now set to an expanded state (also the unconnected state). The tube end form enters the inner diameter of the carrier and pushes the carrier down (i.e., axially displaces the carrier further into the connector body). As the carrier displaces axially within the connector body, it bottoms out or abuts against a step or radially inward extending protrusion. The carrier may create a top half of the cavity for the O-ring gland. In some embodiments, the carrier bottoms out on the bottom of the cavity. In some embodiments, the O-ring gland is already created without the use of the carrier, which protects the tube sealing surface.

During final assembly, the tube end form is inserted into the inner diameter of the connector body, which contains a carrier that is expanding the retaining clip. As the tube end form slides through the inner diameter of the carrier and the connector body, it displaces the carrier in a first axial direction to a step, surface, or protrusion in the inner diameter of the connector body bore while sliding past the retaining clip and retaining clip slot (or groove). When bottomed out (abutting against) on the step, the carrier creates a pocket and serves as the top of the O-ring gland. The retaining clip is now on top of the tube end form shoulder or bead and retains the tube end form within the connector body. Using the carrier as a containment for the O-ring gland allows for easier manufacturability. In some embodiments, the carrier bottoms out on a radially inward extending protrusion within the connector body bore, wherein the protrusion acts as the top of the O-ring gland and protects the tube sealing surface.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a fluid connector;

FIG. 2 is an exploded view of the fluid connector shown in FIG. 1;

FIG. 3 is a cross-sectional view of the connector body and expansion ring taken generally along line 3-3 in FIG. 1, with the expansion ring in an unconnected state;

FIG. 4 is a cross-sectional view of the fluid connector taken generally along line 4-4 in FIG. 1, with the expansion ring in a connected state;

FIG. 5 is a cross-sectional view of a connector body and an expansion ring, with an expansion ring in an unconnected state;

FIG. 6 is a cross-sectional view of a fluid connector assembly in an unconnected state; and,

FIG. 7 is a cross-sectional view of the fluid connector assembly shown in FIG. 6, in a connected state.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

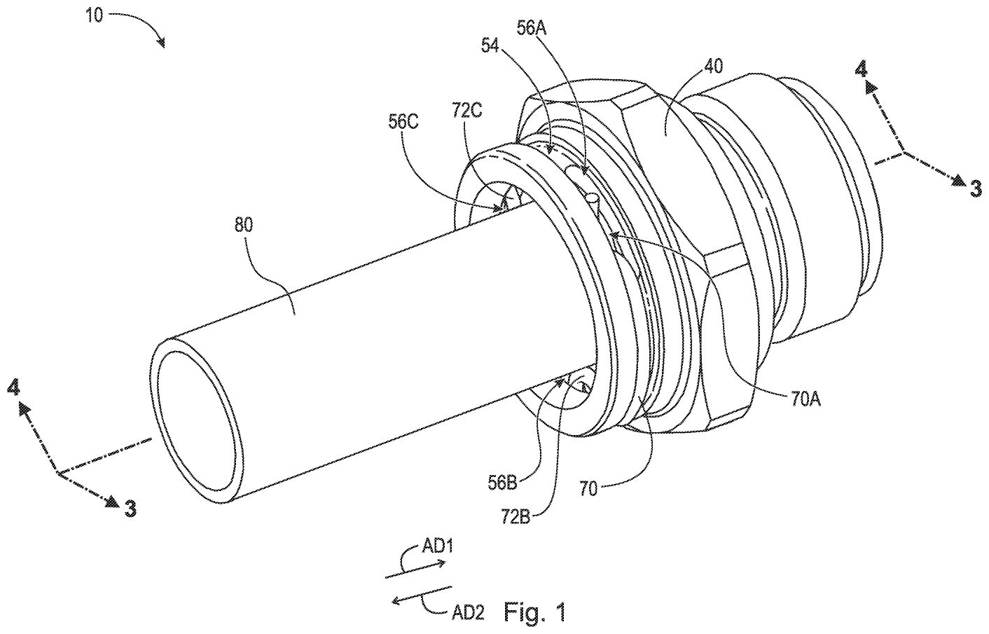

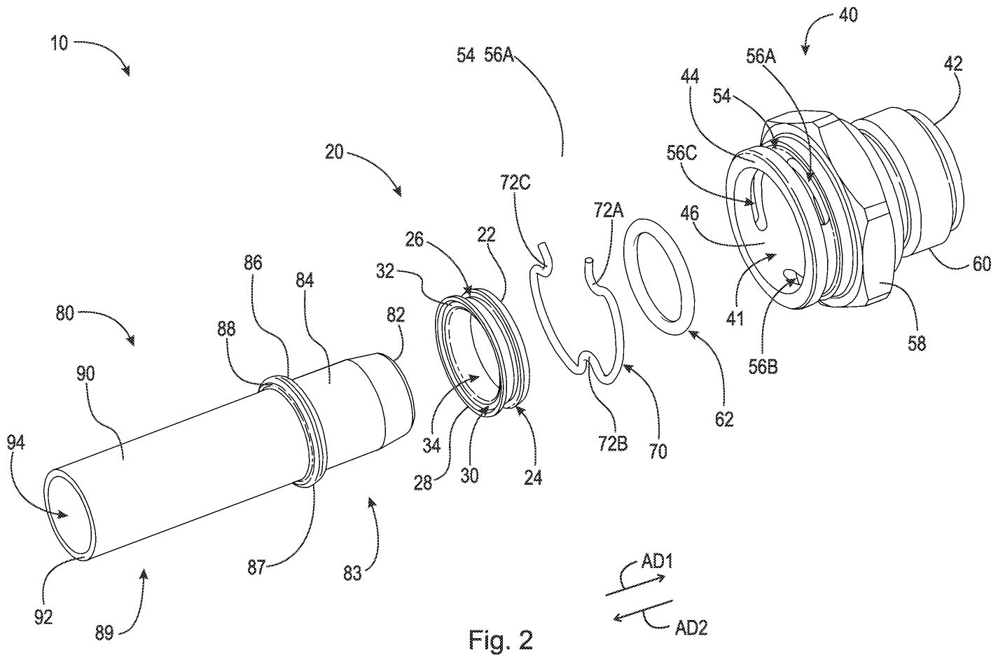

Adverting now to the figures, FIG. 1 is a perspective view of fluid connector 10. FIG. 2 is an exploded view of fluid connector 10. Fluid connector 10 generally comprises expansion ring 20, connector body 40, and tube end form 80. The following description should be read in view of FIGS. 1-4.

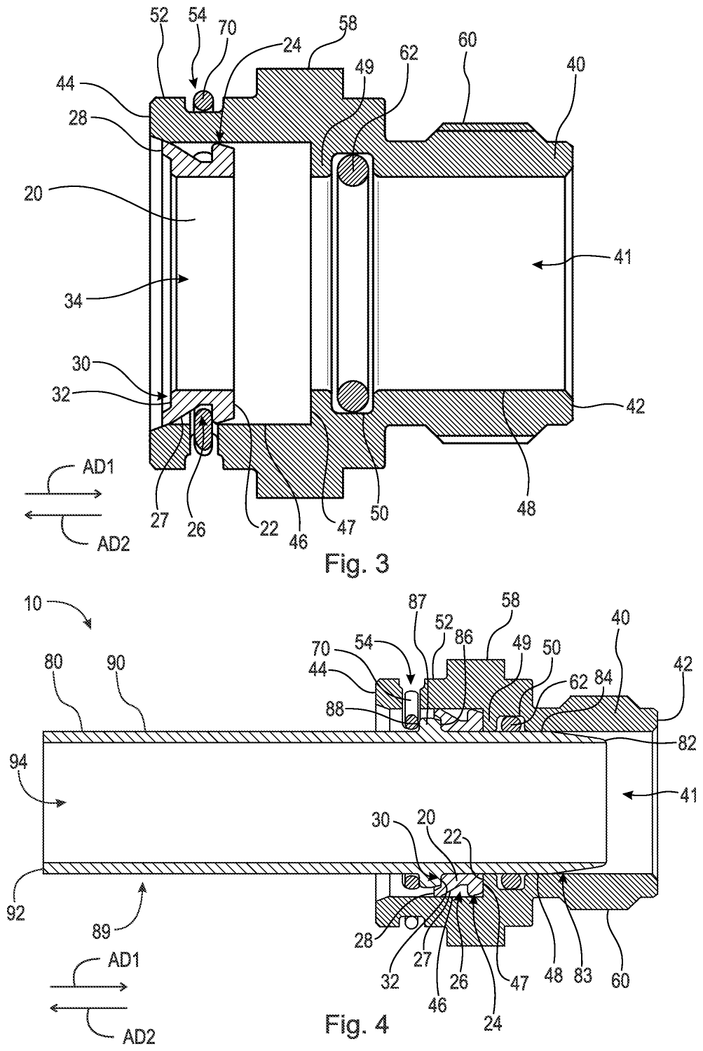

Connector body 40 comprises through-bore 41 extending from end 42 to end 44, radially inward facing surface 46, radially inward facing surface 48, groove 50, radially outward facing surface 52, head 58, and radially outward facing surface 60. Connector body 40 is arranged to be connected to a component that is filled with a fluid. For example, connector body 40 may be connected to a transmission via radially outward facing surface 60, which may comprise external threading. Connector body 40 may be screwed into a threaded hole in the transmission via head 58 (e.g., using a wrench), which is then filled with transmission fluid. In some embodiments, head 58 is hexagonal; however, it should be appreciated that head 58 may comprise any geometry suitable for applying torque to connector body 40. Another component in which fluid connector 10, specifically connector body 40, may be installed into is an engine block. It should be appreciated that fluid connector 10 may be used in various other components, assemblies, and subassemblies in which fluid connection is desired. Seal 62 is arranged in connector body 40. Specifically, seal 62 is arranged in groove 50. In some embodiments, seal 62 is an O-ring. Body 40 further comprises radially inward extending protrusion 49 which forms surface 47. Surface 47 extends between and is connected to radially inward facing surface 46 and radially inward facing surface 48. In the embodiment shown in FIGS. 3-4, protrusion 49 acts as a cavity limit for the seal or O-ring gland (i.e., seal 62 is contained in groove 50 by protrusion 49). Radially outward facing surface 52 further comprises radially outward facing groove 54. Groove 54 comprises apertures 56A-C arranged circumferentially thereabout. Apertures 56A-C extend from groove 54 to through-bore 41. In some embodiments, connector body 40 comprises a metal. In some embodiments, connector body 40 comprises a polymer. In some embodiments, connector body 40 comprises a ceramic.

Retaining clip (or retaining ring or snap clip/ring) 70 is arranged in groove 54 in body 40. Retaining clip 70 is generally a retaining ring including one or more protrusions extending radially inward. In the embodiment shown, retaining clip 70 comprises protrusions 72A-C. Protrusions 72A-C extend radially inward through apertures 56A-C in groove 54. Protrusions 72A-C are arranged to engage bead or shoulder 87, specifically, surface 88, to secure tube end form 80 within connector body 40. Retaining clip 70 may comprise any material that is capable of elastically deforming and returning to its original shape (e.g., metal, polymer, etc.).

Tube end form 80 comprises end 82, section 83, bead or shoulder 87, section 89, end 92, and through-bore 94. Through-bore 94 extends through tube end form 80 from end 82 to end 92. Section 83 is arranged between end 82 and shoulder 87 and comprises radially outward facing surface 84. Radially outward facing surface 84 includes a substantially constant diameter. In some embodiments, radially outward facing surface 84 comprises a frusto-conical taper proximate end 82 (see FIG. 4). Shoulder 87 is arranged between section 83 and section 89 and comprises surface 86 and surface 88. In some embodiments, surface 86 is an axial surface facing at least partially in axial direction AD1 and surface 88 is an axial surface facing at least partially in axial direction AD2. In some embodiments, surface 86 is a frusto-conical surface extending from the radially outward facing surface of shoulder 87 radially inward in axial direction AD1. For example, surface 86 may be a linear conical shape and increases in diameter in axial direction AD2. In some embodiments, surface 86 may comprise linear portion and a conical or frusto-conical portion. Section 89 is arranged between shoulder 87 and end 92 and comprises radially outward facing surface 90. Radially outward facing surface 90 includes a substantially constant diameter. Tube end form 80 is arranged to be inserted, specifically with end 82 first, into connector body 40. Tube end form 80, specifically shoulder 87, which may utilize a straight ramp (i.e., constant linear ramp) or a variable diameter ramp profile, is inserted into connector body 40 until retaining clip 70 snaps over shoulder 87. It should be appreciated that tube end form 80 may be any traditional tube end form comprising a bead, radially outward extending protrusion or flange, or ramp profile, which extends radially outward and axially on the outer surface of the tube end form, to displace a snap ring or wire clip within the connector body to secure the tube end form within the connector body. In some embodiments, tube end form 80 comprises a metal. In some embodiments, tube end form 80 comprises a polymer. In some embodiments, tube end form 80 comprises a ceramic.

Expansion ring 20 is operatively arranged to maintain retaining clip 70 in an expanded state and is slidably engaged with through-bore 41, and specifically radially inward facing surface 46. Expansion ring 20 comprises end 22, radially outward facing surface 24, end 28, and through-bore 34. Radially outward facing surface 24 comprises radially outward facing groove 26. In some embodiments, groove 26 comprises surface 27. Surface 27 may be frusto-conical in shape and increase in diameter in axial direction AD1. Such a frusto-conical surface in groove 26 aids in the disengagement of expansion ring 20 from retaining clip 70, as will be discussed in greater detail below. End 28 may further comprise recess 30 which extends from end 28 in axial direction AD1 thereby forming surface 32. In some embodiments, expansion ring 20 comprises a metal. In some embodiments, expansion ring 20 comprises a polymer. In some embodiments, expansion ring 20 comprises a ceramic.

FIG. 3 is a cross-sectional view of connector body 40 and expansion ring 20 taken generally along line 3-3 in FIG. 1, with expansion ring 20 in an unconnected state. In FIG. 3, tube end form 80 has not yet been inserted into connector body 40. As shown, expansion ring 20 is arranged in through-bore 41 of connector body 40 and axially aligned with groove 54 and retaining clip 70. Expansion ring 20 is slidably engaged with radially inward facing surface 46. Protrusions 72A-C extend through apertures 56A-C and engage groove 26 of retaining clip 70. It should be appreciated that retaining clip 70 is maintained in a radially expanded state when engaged with groove 26 of expansion ring 20. As such, when tube end form 80 is inserted into connector body 40, the radially outward expansion (i.e., radial displacement) of retaining clip 70 required for connection of fluid connector 10 with expansion ring 20 is less than the radially outward expansion (i.e., radial displacement) of retaining clip 70 required for connection of fluid connector 10 without expansion ring 20. In other words, the use of retaining clip 70 lowers the force required to insert tube end form 80 into connector body 40 and properly secure fluid connector 10. To properly secure fluid connector 10, tube end form 80 is inserted, with end 82 first, into through-bore 34 in Axial direction AD1. Shoulder 87 engages end 28 and displaces expansion ring 20 in axial direction AD1, as will be discussed in greater detail below.

FIG. 4 is a cross-sectional view of fluid connector 10 taken generally along line 4-4 in FIG. 1, with expansion ring 20 in a connected state. As shown, tube end form 80 is inserted, with end 82 first, into through-bore 34 (and through-bore 41) in axial direction AD1. Shoulder 87 engages end 28 of expansion ring 20. In some embodiments, shoulder 87 engages recess 30, specifically surface 32. As force is applied to tube end form 80 in axial direction AD1, expansion ring 20, and shoulder 87, is displaced in axial direction AD1 until retaining clip 70 snaps radially inward thereby locking shoulder 87 and expansion ring 20 within connector body 40. In the connected state shown in FIG. 4, end 22 of expansion ring 20 engages with and/or abuts against surface 47 of connector body 40, and retaining clip 70, specifically protrusions 72A-C, engage with and abut against surface 88 of shoulder 87. During this connection process, the frusto-conical shape of groove 26 allows protrusions 72A-C to “ride up” surface 27 in order to disengage expansion ring 20 from retaining clip 70.

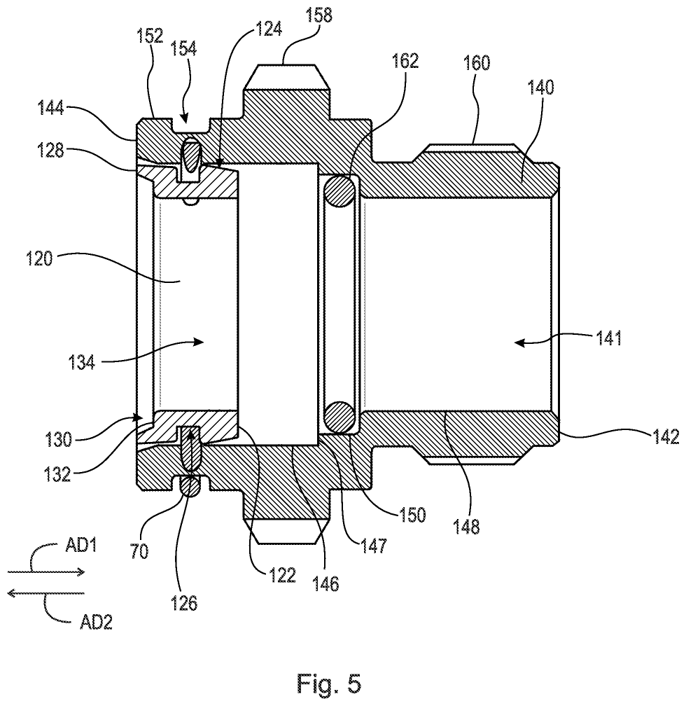

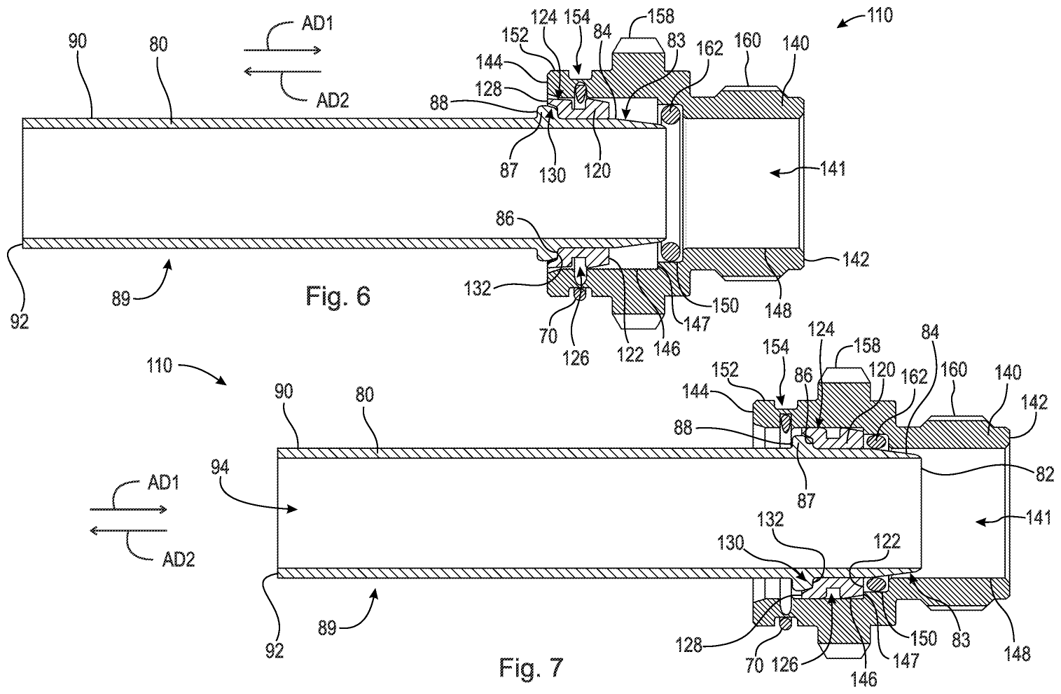

FIG. 5 is a cross-sectional view of connector body 140 and expansion ring 120, with expansion ring 120 in an unconnected state. FIG. 6 is a cross-sectional view of fluid connector assembly 110 in an unconnected state. FIG. 7 is a cross-sectional view of fluid connector assembly 110, in a connected state. Fluid connector 110 generally comprises expansion ring 120, connector body 140, and tube end form 80. The following description should be read in view of FIGS. 5-7.

Connector body 140 comprises through-bore 141 extending from end 142 to end 144, radially inward facing surface 146, radially inward facing surface 148, groove 150, radially outward facing surface 152, head 158, and radially outward facing surface 160. Connector body 140 is arranged to be connected to a component that is filled with a fluid. For example, connector body 140 may be connected to a transmission via radially outward facing surface 160, which may comprise external threading. Connector body 140 may be screwed into a threaded hole in the transmission via head 158 (e.g., using a wrench), which is then filled with transmission fluid. In some embodiments, head 158 is hexagonal; however, it should be appreciated that head 158 may comprise any geometry suitable for applying torque to connector body 140. Another component in which fluid connector 110, specifically connector body 140, may be installed into is an engine block. It should be appreciated that fluid connector 110 may be used in various other components, assemblies, and subassemblies in which fluid connection is desired. Seal 162 is arranged in connector body 140. Specifically, seal 162 is arranged in groove 150. In some embodiments, seal 162 is an O-ring. Body 140 further comprises surface 147, which extends between and is connected to radially inward facing surface 146 and groove 158. In the embodiment shown in FIGS. 5-7, body 140 by itself does not comprise a cavity limit for the seal or O-ring gland (i.e., seal 162 is arranged in groove 50 but is not prevented from movement in axial direction AD2). In the embodiment shown, expansion ring 120 provides the axial limit for the seal or O-ring gland, as will be described in greater detail below. Radially outward facing surface 152 further comprises radially outward facing groove 154. Groove 154 comprises apertures 156A-C (not shown) arranged circumferentially thereabout. Apertures 156A-C (not shown) extend from groove 154 to through-bore 141. In some embodiments, connector body 140 comprises a metal. In some embodiments, connector body 140 comprises a polymer. In some embodiments, connector body 140 comprises a ceramic.

Retaining clip (or retaining ring or snap clip/ring) 70 is arranged in groove 154 in body 140. Protrusions 72A-C extend radially inward through apertures 156A-C in groove 154. Protrusions 72A-C are arranged to engage bead or shoulder 87, specifically, surface 88, to secure tube end form 80 within connector body 140. Retaining clip 70 may comprise any material that is capable of elastically deforming and returning to its original shape (e.g., metal, polymer, etc.).

Expansion ring 120 is operatively arranged to maintain retaining clip 70 in an expanded state and is slidably engaged with through-bore 141, and specifically radially inward facing surface 146. Expansion ring 120 comprises end 122, radially outward facing surface 124, end 212, and through-bore 134. Radially outward facing surface 124 comprises radially outward facing groove 126. End 128 may further comprise recess 130 which extends from end 128 in axial direction AD1 thereby forming surface 132. In some embodiments, expansion ring 120 comprises a metal. In some embodiments, expansion ring 120 comprises a polymer. In some embodiments, expansion ring 120 comprises a ceramic.

In FIGS. 5 and 6, tube end form 80 has not yet been fully inserted into connector body 140. As shown, expansion ring 120 is arranged in through-bore 141 of connector body 140 and axially aligned with groove 154 and retaining clip 70. Expansion ring 120 is slidably engaged with radially inward facing surface 146. Protrusions 72A-C extend through apertures 156A-C (not shown) and engage groove 126 of retaining clip 70. It should be appreciated that retaining clip 70 is maintained in a radially expanded state when engaged with groove 126 of expansion ring 120. As such, when tube end form 80 is inserted into connector body 140, the radially outward expansion (i.e., radial displacement) of retaining clip 70 required for connection of fluid connector 110 with expansion ring 120 is less than the radially outward expansion (i.e., radial displacement) of retaining clip 70 required for connection of fluid connector 110 without expansion ring 120. In other words, the use of retaining clip 70 lowers the force required to insert tube end form 80 into connector body 140 and properly secure fluid connector 110. To properly secure fluid connector 110, tube end form 80 is inserted, with end 82 first, into through-bore 134 in Axial direction AD1, as shown in FIG. 6. Shoulder 87 engages end 128 and displaces expansion ring 120 in axial direction AD1, as will be discussed in greater detail below.

FIG. 7 is a cross-sectional view of fluid connector assembly 110, in a connected state. As shown, tube end form 80 is inserted, with end 82 first, into through-bore 134 (and through-bore 141) in axial direction AD1. Shoulder 87 engages end 128 of expansion ring 120. In some embodiments, shoulder 87 engages recess 130, specifically surface 132. As force is applied to tube end form 80 in axial direction AD1, expansion ring 120, and shoulder 87, is displaced in axial direction AD1 until retaining clip 70 snaps radially inward thereby locking shoulder 87 and expansion ring 120 within connector body 140. In the connected state shown in FIG. 7, end 122 of expansion ring 120 engages with and/or abuts against surface 147 of connector body 140, and retaining clip 70, specifically protrusions 72A-C, engage with and abut against surface 88 of shoulder 87. Additionally, in the embodiment shown, when fluid connector assembly 110 is in the connected state, end 122 of expansion ring 120 provides the cavity limit for the seal or O-ring gland (i.e., seal 162 is contained in groove 50 by end 122 of expansion ring 120).

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Fluid connector
20 Expansion ring
22 End
24 Radially outward facing surface
26 Groove
27 Surface
28 End
30 Recess
32 Surface
34 Through-bore
40 Connector body
41 Through-bore
42 End
44 End
46 Radially inward facing surface
47 Surface
48 Radially inward facing surface
49 Protrusion
50 Groove
52 Radially outward facing surface
54 Groove
56A Aperture
56B Aperture
56C Aperture
58 Head
60 Radially outward facing surface
62 Seal
70 Retaining clip
72A Protrusion
72B Protrusion
72C Protrusion
80 Tube end form
82 End
83 Section
84 Radially outward facing surface
86 Surface
87 Shoulder or bead
88 Surface
89 Section
90 Radially outward facing surface
92 End
94 Through-bore
110 Fluid connector
120 Expansion ring
122 End
124 Radially outward facing surface
126 Groove
128 End
130 Recess
132 Surface
134 Through-bore
140 Connector body
141 Through-bore
142 End
144 End
146 Radially inward facing surface
147 Surface
148 Radially inward facing surface
150 Groove
152 Radially outward facing surface
154 Groove
156A Aperture (not shown)
156B Aperture (not shown)
156C Aperture (not shown)
158 Head
160 Radially outward facing surface
162 Seal
AD1 Axial direction
AD2 Axial direction

What is claimed is:

1. An expansion ring for a fluid connector including a connector body having a bore, a retaining clip, and a tube end form, the expansion ring comprising:
a first end;
a second end;
a radially outward facing surface; and,
a through-bore;
wherein the expansion ring is slidably engaged with the connector body.

2. The expansion ring as recited in claim 1, wherein the radially outward facing surface comprises a groove.

3. The expansion ring as recited in claim 2, wherein the groove comprises a frusto-conical surface.

4. The expansion ring as recited in claim 2, wherein the groove is operatively arranged to engage with the retaining clip to maintain the retaining clip in an at least partially radially expanded state.

5. The expansion ring as recited in claim 2, wherein:
in an unconnected state, the expansion ring is axially aligned with the retaining clip; and,
in a connected state, the tube end form displaces the expansion ring in a first axial direction and the expansion ring and a shoulder of the tube end form are secured in the bore of the connector body.

6. The expansion ring as recited in claim 1, wherein the second end comprises a recess forming a surface.

7. The expansion ring as recited in claim 6, wherein the surface is operatively arranged to engage with a shoulder of the tube end form.

8. A fluid connector, comprising:
a connector body, including:
a first through-bore;
a first groove arranged circumferentially within the first through-bore;
a seal arranged within the first groove; and,
a retaining clip operatively arranged on the connector body to extend into the first through-bore; and,
an expansion ring, including:
a first end;
a second end;
a radially outward facing surface; and,
a second through-bore, wherein the expansion ring is slidably engaged in the first through-bore.

9. The fluid connector as recited in claim 8, wherein in an unconnected state, the expansion ring is axially aligned with the retaining clip and the radially outward facing surface maintains the expansion ring in an at least partially radially expanded state.

10. The fluid connector as recited in claim 9, wherein the radially outward facing surface comprises a second groove.

11. The fluid connector as recited in claim 10, wherein the second groove comprises a frusto-conical surface.

12. The fluid connector as recited in claim 9, wherein in a connected state, a tube end form displaces the expansion ring in a first axial direction and the expansion ring and the tube end form are secured in the first through-bore of the connector body.

13. The fluid connector as recited in claim 12, wherein in a connected state, the first end encloses the seal within the first groove.

14. The fluid connector as recited in claim 8, wherein the connector body further comprises a protrusion that encloses the seal within the first groove.

15. The fluid connector as recited in claim 8, wherein the second end comprises a recess forming a surface.

16. The fluid connector as recited in claim 15, wherein the surface is operatively arranged to engage with a shoulder of the tube end form.

17. A fluid connector, comprising:
a connector body, including:
a first through-bore;
a first groove arranged circumferentially within the first through-bore;
a seal arranged within the first groove; and,
a retaining clip operatively arranged on the connector body to extend into the first through-bore;
an expansion ring slidably engaged in the first through-bore, the expansion ring including:
a first end;
a second end;
a radially outward facing surface including a second groove; and,
a second through-bore; and,
a tube end form operatively arranged to be connected to the connector body.

18. The fluid connector as recited in claim 17, wherein in an unconnected state, the second groove is engaged with the retaining clip and the retaining clip is maintained in an at least partially radially expanded state.

19. The fluid connector as recited in claim 18, wherein in a connected state, the tube end form displaces the expansion ring in a first axial direction within the first through-bore and the expansion ring and the tube end form are secured in the connector body via the retaining clip.

20. The fluid connector as recited in claim 19, wherein in the connected state, the first end encloses the seal within the first groove.
